(19) United States
(12) Patent Application Publication
(10) Pub. No.: US 2007/0013689 A1
(43) Pub. Date: Jan. 18, 2007

(54) DISPLAY APPARATUS WITH USB HUB

(76) Inventor: Byeong-bae CHOI, Hwaseong-si (KR)

Correspondence Address: STANZIONE & KIM, LLP, 919 18TH STREET, N.W., SUITE 440, WASHINGTON, DC, 20006, US

(21) Appl. No.: 11/427,933

(22) Filed: Jun. 30, 2006

(30) Foreign Application Priority Data
Jul. 12, 2005 (KR) 2005-62717

(51) Int. Cl. G09G 5/00

(52) U.S. Cl. 345/211

(57) ABSTRACT

A display apparatus includes an up stream port to which an external control system is connectable, a down stream port to which a peripheral device is connectable, a USB hub to transmit up stream data from the up stream port to the down stream port, a USB power supply to supply power to the USB hub, and a USB power controller to sense whether the external control system is connected to the up stream port, and to intercept the power from the USB power supply when the external control system is not connected to the up stream port. Thus, the display apparatus can satisfy standards of power consumption regulated by an EPA in an off mode of a DPMS.

### CROSS-REFERENCE TO RELATED APPLICATIONS

This application claims the benefit of Korean Patent Application No. 2005-062717 filed on Jul. 12, 2005, in the Korean Intellectual Property Office, the disclosure of which is incorporated herein by reference in its entirety.

### BACKGROUND OF THE INVENTION

1. Field of the Invention

The present general inventive concept relates to a display apparatus with a universal serial bus (USB) hub, and more particularly, to a display apparatus with a USB hub, which has a circuit to control power consumption.

2. Description of the Related Art

Many display apparatuses having a USB hub have recently been developed. A display apparatus having a USB hub includes an up stream port to which a computer is connected, and a down stream port to which a USB peripheral device is connected. Here, the computer and the USB peripheral device can communicate with each other through the USB hub provided in the display apparatus. Thus, the USB hub is provided in the display apparatus, so that the USB peripheral device such as a keyboard, a mouse, or the like can be connected to the display apparatus, thereby improving user convenience.

The environmental protection agency (EPA) regulates standards of power consumption in the display apparatus. In particular, the EPA regulates the standards of the power consumption in a normal state, a display power management system (DPMS), etc. in which peripheral devices that are connected to the display apparatus are turned off and only a signal source such as the computer (or the like) is connected to the display apparatus.

Particularly, the EPA limits the power consumption in an off mode of the DPMS to 1 W or below when the display apparatus is turned off.

However, when the display apparatus that has the USB hub is used, even though power supplied to the up stream port and the down stream port is intercepted, a USB chip associated with the USB hub consumes power itself when the power is supplied to the USB chip that creates a USB interface, thereby making it difficult to satisfy the standards regulated by the EPA.

For example, in the case where two or less down stream ports are provided, the USB chip can be driven by Vcc power supplied to the up stream port, so that it is possible to satisfy the standards regulated by the EPA. On the other hand, when three or more down stream ports are provided, the Vcc power supplied to the up stream port is limited, so that the down stream port cannot be normally operated.

In this case, a separate power source is needed to drive the USB hub. However, when the USB hub is driven by the separate power source, it is difficult to satisfy the standards regulated by the EPA.

### SUMMARY OF THE INVENTION

The present general inventive concept provides a display apparatus that can satisfy standards of power consumption regulated by the EPA in an off mode of a display power management system (DPMS).

Additional aspects of the general inventive concept will be set forth in part in the description which follows and, in part, will be obvious from the description, or may be learned by practice of the general inventive concept.

The foregoing and/or other aspects of the present general inventive concept are achieved by providing a display apparatus comprising an up stream port to which an external control system is connectable, a down stream port to which a peripheral device is connectable, a USB hub to transmit up stream data from the up stream port to the down stream port, a USB power supply to supply power to the USB hub, and a USB power controller to sense whether the external control system is connected to the up stream port, and to intercept the power from the USB power supply when the external control system is not connected to the up stream port.

The USB power controller may supply the power from the USB power supply to the USB hub when the external control system is connected to the up stream port.

The USB power controller may comprise a DC-DC converter.

The DC-DC converter may comprise an up stream sensing pin to sense whether the external control device is connected to the up steam port.

The DC-DC converter may convert the power from the USB power supply to have a predetermined level and may supply the power having the predetermined level from the USB power supply to the USB hub when the up stream sensing pin senses that the external control system is connected to the up stream port.

The external control system may comprise a computer.

The foregoing and/or other aspects of the present general inventive concept are also achieved by providing a display apparatus with a USB hub, comprising a USB power supply to supply power to the USB hub, and a USB power controller to intercept the power from the USB power supply when an external control system is not connected to the USB hub, and to supply the power from the USB power supply to the USB hub when the external control system is connected to the USB hub.

The USB hub may comprise an up stream port to which the external control system is connectable, and a down stream port to which a peripheral device is connectable, and the USB power controller may comprise a sensor to sense whether the external control system is connected to the up stream port.

The foregoing and/or other aspects of the present general inventive concept are also achieved by providing a display apparatus comprising an up stream port to which an external control system is connectable, a down stream port to which a peripheral device is connectable, a USB hub to transmit up stream data from the up stream port to the down stream port, and a USB power controller to sense whether the external control system is connected to the up stream port and to intercept power to be supplied to the USB hub when the external control system is not connected to the up stream port.

The USB power controller may supply the power to the USB hub when the external control system is connected to the up stream port.

The foregoing and/or other aspects of the present general inventive concept are also achieved by providing a display apparatus, comprising a USB hub, a USB power supply to supply power to the USB hub, and a USB power controller to block the power from the USB power supply to the USB hub when the display apparatus is determined not to be in an on mode, and to supply the power from the USB power supply to the USB hub when the display apparatus is determined not to be in the on mode.

The foregoing and/or other aspects of the present general inventive concept are also achieved by providing a power controller usable with a USB hub in a display apparatus, the power controller comprising a converting unit to receive a first DC voltage, to determine whether the display apparatus is in an on mode according to one or more external connections to the USB hub, to provide a second DC voltage to the USB hub when the display apparatus is determined to be in the on mode, and not to provide any power to the USB hub when the display apparatus is determined not to be in the on mode.

The foregoing and/or other aspects of the present general inventive concept are also achieved by providing a display apparatus, comprising a USB hub, a USB power supply to supply power to the USB hub, and a USB power controller to operate the display apparatus in a first mode in which the power from the USB power supply is blocked from the USB hub and a second mode in which the power from the USB power supply is supplied to the USB hub.

The foregoing and/or other aspects of the present general inventive concept are also achieved by providing a method of controlling a display apparatus having a USB hub, the method comprising detecting whether an external control system is connected to a first port of the USB hub, providing power to the USB hub when the external control system is connected to the first port of the USB hub, and blocking power to the USB hub when the external control system is not connected to the first port of the USB hub.

### BRIEF DESCRIPTION OF THE DRAWINGS

These and other aspects of the present general inventive concept will become apparent and more readily appreciated from the following description of the embodiments, taken in conjunction with the accompany drawings of which:

FIGS. 1 and 2 are control block diagrams of a display apparatus with a USB hub according to an embodiment of the present general inventive concept; and

FIG. 3 is a control flowchart of a display apparatus with a USB hub according to another embodiment of the present general inventive concept.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

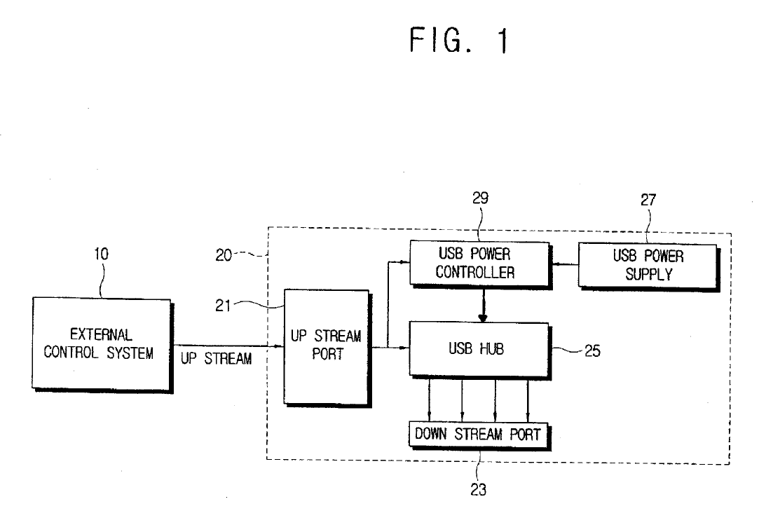

FIG. 1 is a control block diagram illustrating a display apparatus 20 with a USB hub 25 according to an embodiment of the present general inventive concept.

As illustrated in FIG. 1, the display apparatus 20 includes an up stream port 21, a down stream port 23, a USB hub 25, a USB power supply 27, and a USB power controller 29.

The up stream port 21 is provided so that an external control system 10 can be connected thereto. Therefore, a data line, a power supplying line, and a ground line are connected to the up stream port 21 through a USB jack, and up stream data and power input through the up stream port 21 are supplied to the USB hub 25.

The down stream port 23 is provided so that a USB peripheral device such as a keyboard, a mouse, a memory stick, a camcorder, a digital camera, etc. can be connected thereto through a connector such as a USB jack. Like the up stream port 21, the down stream port 23 is also connected to the data line and the power supplying line. The down stream port 23 can supply the power to the USB peripheral device through a power supplying pin. Accordingly, a separate power supply is not needed to supply the power to the USB peripheral device, since the USB peripheral device receives power through the USB hub 25 via the power supplying pin.

The USB hub 25 is used as an interface between the external control system 10 connected to the up stream port 21 and the USB peripheral device connected to the down stream port 23. Thus, the USB hub 25 includes a control circuit and a power circuit for a USB communication interface.

Here, the USB hub 25 and the down stream port 23 can be driven by the power supplied through the power supplying line of the up stream port 21. However, according to an embodiment of the present general inventive concept, the USB hub 25 and the down stream port 23 receive power from the display apparatus 20 that is limited based on a number of the down stream ports included in the down stream port 23. As illustrated in FIG. 1, the USB hub 25 receives the power through the USB power supply 27.

The USB power controller 29 senses whether the external control system 10 is connected to the up stream port 21, and controls the power to be supplied to the USB hub 25 and/or the down stream port 23. Here, the USB power controller 29 can be achieved by a DC-DC converter, a switching unit, and/or the like. Further, the USB power controller 29 includes a sensor to sense whether the up stream port 21 and the external control system 10 are connected to each other.

When the external control system 10 is connected to the up stream port 21, the USB power controller 29 controls the power to be supplied from the USB power supply 27 to the USB hub 25. On the other hand, when the external control system 10 is not connected to the up stream port 21, the USB power controller 29 intercepts the power from the USB power supply 27 and does not provide the intercepted power to the USB hub 25. Thus, the USB power controller 29 can determine whether the display apparatus 20 is in an off mode of a display power management system based on whether the external control system 10 is connected to the upstream port 20, and the USB power controller 29 can regulate power, accordingly.

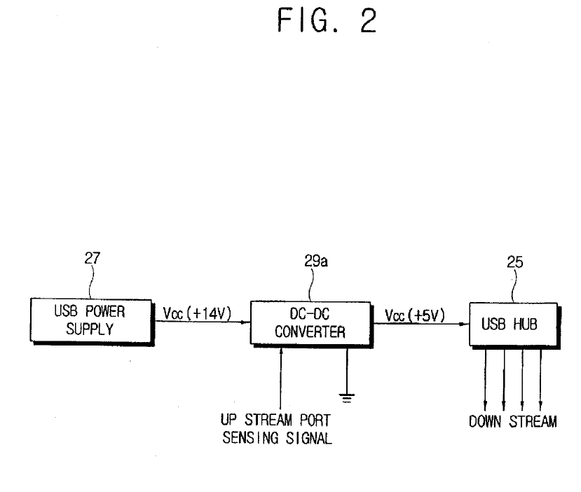

Below, the USB power controller 29 will be described in more detail with reference to FIG. 2.

As illustrated in FIG. 2, the USB power controller 29 includes a DC-DC converter 29a having a sensing pin to receive a sensing signal of the up stream port 21.

The DC-DC converter 29a supplies or intercepts the power supplied from the USB power supply 27 to the USB hub 25 based on the sensing signal received from the sensing pin of the up stream port 21.

In particular, the DC-DC converter 29a operates when the external control system 10 is connected to the up stream port 21 as indicated when a high signal is input to the up stream sensing pin. For example, when the up stream sensing pin senses the high signal, the DC-DC converter 29a converts a voltage of 14V supplied from the USB power supply 27 into a voltage of 5V, and supplies the voltage of 5V to the USB hub 25. Therefore, the USB hub 25 can operate normally as the USB interface using the voltage of 5V. Other voltages may also be used.

The DC-DC converter 29a may be designed to not output a voltage when the external control system 10 is not connected to the up stream port 21. Therefore, when the external control system 10 is not connected to the up stream port 21, the power is not supplied to the USB hub 25, thereby disabling the USB hub 25.

Thus, the power that would be consumed in the USB hub 25 itself of the display apparatus 20 is intercepted. Accordingly, when the USB power controller 29 determines that the display apparatus 20 is in the off mode, power may not actually be provided to a USB chip (not shown) associated with the USB hub 25. In other words, the USB power controller 29 may be separate from the USB chip.

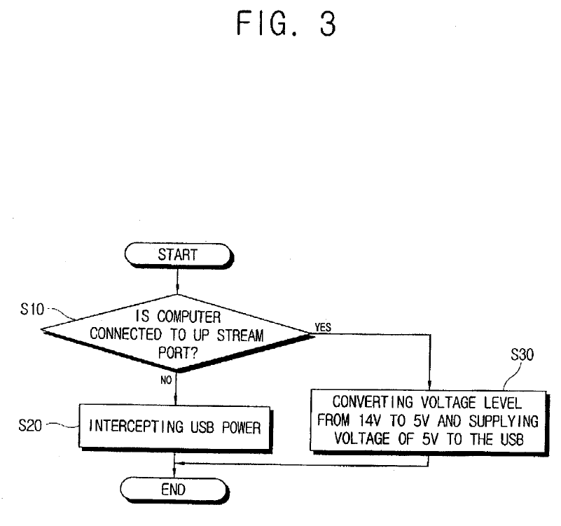

FIG. 3 is a control flowchart illustrating a method of controlling a display apparatus with a USB hub according to another embodiment of the present general inventive concept. The control method may be used to control the display apparatus 20 of FIG. 1. Accordingly, the control method of FIG. 3 is described below with reference to FIGS. 1 to 3.

As illustrated in FIG. 3, at operation S10, the USB power controller 29 senses whether the external control system 10 (e.g., a computer) is connected to the up stream port 21.

When the computer is not connected to the up stream port 21, the USB power controller 29 intercepts the power supplied to the USB hub 25 and/or the down stream port 23 at operation S20.

On the other hand, when the computer is connected to the up stream port 21, at the USB power controller 29 lowers a voltage of 14V supplied from the USB power supply 27 into a driving voltage of 5V, thereby supplying the driving voltage of 5V to the USB hub 25 and/or the down stream port 23 at operation S30. Other voltages may also be used to power the USB hub 25.

Thus, the power consumed in the USB hub 25 itself of the display apparatus 20 is controlled according to whether the computer is connected to the up stream port 21, and in the off mode, no power is consumed by the USB hub 25.

As described above, the embodiments of the present general inventive concept provide a display apparatus that can satisfy power consumption based on EPA standards in an off mode of a DPMS.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
an up stream port to which an external control system is connectable;
a down stream port to which a peripheral device is connectable;
a USB hub to transmit up stream data from the up stream port to the down stream port;
a USB power supply to supply power to the USB hub; and
a USB power controller to sense whether the external control system is connected to the up stream port, and to intercept the power from the USB power supply when the external control system is not connected to the up stream port.

2. The display apparatus according to claim 1, wherein the USB power controller supplies the power from the USB power supply to the USB hub when the external control system is connected to the up stream port.

3. The display apparatus according to claim 2, wherein the USB power controller comprises a DC-DC converter.

4. The display apparatus according to claim 3, wherein the DC-DC converter comprises an up stream sensing pin to sense whether the external control device is connected to the up steam port.

5. The display apparatus according to claim 4, wherein the DC-DC converter converts the power from the USB power supply to have a predetermined level and supplies the power having the predetermined level from the USB power supply to the USB hub when the up stream sensing pin senses that the external control system is connected to the up stream port.

6. The display apparatus according to claim 5, wherein the external control system comprises a computer.

7. The display apparatus according to claim 1, wherein the external control system comprises a computer.

8. A display apparatus with a USB hub, comprising:
a USB power supply to supply power to the USB hub; and
a USB power controller to intercept the power from the USB power supply when a external control system is not connected to the USB hub, and to supply the power from the USB power supply to the USB hub when the external control system is connected to the USB hub.

9. The display apparatus according to claim 8, wherein the USB hub comprises:
an up stream port to which the external control system is connectable; and
a down stream port to which a peripheral device is connectable, and the USB power controller comprises a sensor to sense whether the external control system is connected to the up stream port.

10. The display apparatus according to claim 9, wherein:
the external control system comprises a computer; and
the peripheral device comprises one or more of a keyboard, a mouse, a memory stick, a camcorder, and a digital camera.

11. A display apparatus, comprising:
an up stream port to which an external control system is connectable;
a down stream port to which a peripheral device is connectable;
a USB hub to transmit up stream data from the up stream port to the down stream port; and
a USB power controller to sense whether the external control system is connected to the up stream port, and to intercept power to be supplied to the USB hub when the external control system is not connected to the up stream port.

12. The display apparatus according to claim 11, wherein the USB power controller supplies the power to the USB hub when the external control system is connected to the up stream port.

13. The display apparatus according to claim 11, wherein the USB hub comprises a communication interface between the up steam port and the external control system connectable thereto and the down stream port and the peripheral device connectable thereto.

14. A display apparatus, comprising:
a USB hub;
a USB power supply to supply power to the USB hub; and
a USB power controller to block the power from the USB power supply to the USB hub when the display apparatus is determined not to be in an on mode, and to supply the power from the USB power supply to the USB hub when the display apparatus is determined to be in the on mode.

15. A power controller usable with a USB hub in a display apparatus, the power controller comprising:
a converting unit to receive a first DC voltage, to determine whether the display apparatus is in an on mode according to one or more external connections to the USB hub, to provide a second DC voltage to the USB hub when the display apparatus is determined to be in the on mode, and not to provide any power to the USB hub when the display apparatus is determined not to be in the on mode.

16. The power controller according to claim 15, wherein the USB hub is implemented with a USB chip separate from the power controller.

17. The power controller according to claim 15, wherein the first DC voltage is 14V and the second DC voltage is 5V.

18. The power control according to claim 15, further comprising:
a sensing unit in communication with the converting unit to sense whether a computer is connected to an up steam port on the USB hub, to determine that display apparatus is not in the on mode when the computer is not connected to the up stream port on the USB hub, and to determine that the display apparatus is in the on mode when the computer is connected to the upstream port on the USB hub.

19. A display apparatus, comprising:
a USB hub;
a USB power supply to supply power to the USB hub; and
a USB power controller to operate the display apparatus in a first mode in which the power from the USB power supply is blocked from the USB hub and a second mode in which the power from the USB power supply is supplied to the USB hub.

20. The display apparatus according to claim 19, wherein in the second mode the power from the USB power supply is provided to a peripheral device connected to the USB hub.

21. The display apparatus according to claim 19, wherein the USB power controller operates the display apparatus in the first mode when the display apparatus is in an off mode of a display power management system, and the second mode when a computer is connected to the USB hub.

22. A method of controlling a display apparatus having a USB hub, the method comprising:
detecting whether an external control system is connected to a first port of the USB hub;
providing power to the USB hub when the external control system is connected to the first port of the USB hub; and
blocking power to the USB hub when the external control system is not connected to the first port of the USB hub.

23. The method according to claim 22, wherein the providing of the power to the USB hub comprises providing the power to a peripheral device connected to a second port of the USB hub.
